(19) United States
(12) Patent Application Publication
(10) Pub. No.: US 2012/0262612 A1
(43) Pub. Date: Oct. 18, 2012

(54) ELECTRO OPTICAL MODULATOR, ELECTRO OPTICAL SENSOR, AND DETECTING METHOD THEREOF

(75) Inventors: YONG TONG ZOU, HSINCHU CITY (TW); HAU WEI WANG, TAIPEI CITY (TW); DING KUN LIU, HSINCHU COUNTY (TW)

(73) Assignee: INDUSTRIAL TECHNOLOGY RESEARCH INSTITUTE, HSINCHU (TW)

(21) Appl. No.: 13/398,558

(22) Filed: Feb. 16, 2012

Related U.S. Application Data
(60) Provisional application No. 61/476,557, filed on Apr. 18, 2011.

(30) Foreign Application Priority Data
Sep. 6, 2011 (TW) 100132013

(51) Int. Cl. H04N 5/335; G02F 1/1334; G02F 1/03; G02F 1/00

(52) U.S. Cl. 348/294; 359/237; 349/86; 348/E05.091

(57) ABSTRACT

The disclosure relates to an electro optical sensor, which comprises a light source generating device, an electro optical modulator, a supporting module, and an image capturing module. The light source generating device emits a light beam. After the electro optical modulator modulates the light beam, the modulated light beam emits onto a subject. The supporting module includes a transparent substrate, supporting the subject and allowing the modulated light beam to incidentally emit into the transparent substrate. The image capturing module converts the light beam reflected from the supporting module into a video signal.

### TECHNICAL FIELD

The disclosure relates to an electro optical modulator, an electro optical sensor, and a detecting method thereof. Particularly, the disclosure relates to the electro optical modulator, the electro optical sensor, and the detecting method thereof applied for a flexible subject.

### BACKGROUND

Traditional circuit detecting devices utilize a probe to detect a subject and apply voltage for monitoring the circuit conditions such as short circuit, open circuit, and so on. Conventional contacting-probe devices are usually applied for the detection of the processes of semiconductor dies and printed circuit boards (PCBs). As the line width in the semiconductor process becomes more and more narrow, limitations of probe detection emerge. In addition, the probe required for detecting small line widths is very expensive. With increasingly challenging requirements for large-dimension detection, increasing detection speeds, and ability to detect total samples, it is no longer cost effective to utilize traditional probe designs for sampling to detect circuit.

If the subject is incompletely etched by the lithographic process, defective pixels could occur and result in reduced yield rate. Additionally, during the process, several phenomenons such as short circuit, open circuit, doping, and scratching might occur in the circuits. To reduce process cost and ensure product quality, the above-mentioned phenomenon can be quickly detected by a non-contact sensor.

FIG. 1 is a broad view illustrating a conventional electro-optic sensor. As shown in FIG. 1, the conventional electro-optic sensor 100 comprises a light source 14 for generating light, a modulator 10 for modulating the light from the light source 14 towards its minor coating 10-3 and transmitting the light reflected from the mirror coating 10-3 at a certain ratio determined by the strength of its electric field, a beam splitter 12, a lens 16 for focusing the light emitted from the modulator 10, a CCD camera 17 for converting the focused light to an analog video signal, and an image processor 18 for converting the analog video signal to a digital video signal. The digital video signal is displayed on a monitor 20 for analysis. The modulator 10 includes a modulator body 10-2, a mirror coating 10-3 and a support frame 10-1. The modulator body 10-2 having a hexagonal shape is supported by the support frame 10-1. A conducting film is disposed on the lateral side of the modulator body 10-2. The minor coating 10-3 formed of a thin metal foil is formed on the lower portion of the modulator body 10-2. The modulator body 10-2 includes an electrode commonly connecting with an external voltage source which supplies a reference voltage, and an electro-optic portion formed in the modulator body 10-2 for dispersing the incident light through the modulator body 10-2 and transmitting the reflected light towards the beam splitter 12 at a certain ratio determined by the strength of the electric field in the modulator body 10-2.

The incident light from the light source 14 traverses the modulator body 10-2 and is reflected by the minor coating 10-3. The reflected light traverses through the modulator body 10-2 and is emitted from the modulator 10 towards the beam splitter 12. During this process, the incident light traverses the modulator body 10-2 and is dispersed therethrough at a certain ratio determined by the strength of the electric field in the modulator body 10-2. Consequently, the light emitting from the modulator 10 has a level that is varied by the electric field strength of the modulator body 10-2.

In accordance with different gray scales of a digital image, it can be determined whether the residue of the conducting material contaminates the circuits of the subject based on calculation of the effect of the residue on the surface pattern of the subject. As shown in FIG. 1, the modulator 10 has to maintain a distance (about 10 μm) from the subject 22 and is charged with a voltage to form a capacitive effect, which generates an induced electric field to drive the electro optical modulator 10. The gap (about 10 μm) is so narrow that the mirror coating 10-3 of the modulator 10 is easily abraded by the subject 22, which increases the maintenance cost. In addition, the mirror coating 10-3 cannot be coated by traditional coating methods, thereby increasing manufacturing cost.

In order to improve the abrasion resistance of the minor coating 10-3, the conventional technique usually coats a passivation layer on the mirror coating 10-3 to prevent direct abrasion. However, the above-mentioned technique does not allow quick measurement of flexible subjects such as flexible printed boards.

Moreover, general appearance detecting methods cannot obtain the circuit condition of the transparent conducting film (such as ITO or AZO) in the subject. Since the subject (such as contacting panel) has high transmittance (greater than 90%), the image contrast obtained by the general automatic optical inspection system (AOI) is relatively low (especially if there are two layers of ITO structure in the bridge portion) so as to cause misreading of the image.

### SUMMARY

The present disclosure provides an electro optical modulator. The electro optical modulator comprises a body, a conducting film, and a transparent film. The body includes a first surface and a second surface. The conducting film is disposed on the first surface. The transparent film is disposed on the second surface and is located above a subject.

The present disclosure provides an electro optical sensor. The electro optical sensor comprises a light source generating device, an electro optical modulator, a supporting module, and an image capturing module. The light source generating device emits a light beam. The electro optical modulator modulates the light beam, which emits onto a subject. The supporting module supports the subject and allows the modulated light beam to emit onto the subject. The image capturing module converts the light beam reflected from the electro optical modulator to a video signal.

The present disclosure provides a detecting method, which comprises the following steps: applying a voltage on a subject; grounding an electro optical modulator; projecting the light beam onto the electro optical modulator; retrieving the video signal of the electro optical modulator; and judging whether the subject is defective in accordance with the video signal.

The foregoing has outlined rather broadly the features and technical benefits of the disclosure in order that the detailed description of the invention that follows may be better understood. Additional features and benefits of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes of the disclosure. It should also be realized by those skilled in the art that such equivalent constructions do not depart from the spirit and scope of the invention as set forth in the appended claims.

### BRIEF DESCRIPTION OF THE DRAWINGS

The accompanying drawings, which are incorporated in and constitute a part of this specification, illustrate embodiments of the disclosure and, together with the description, serve to explain the principles of the invention.

FIG. 1 illustrates a perspective view of a conventional electro optical sensor;

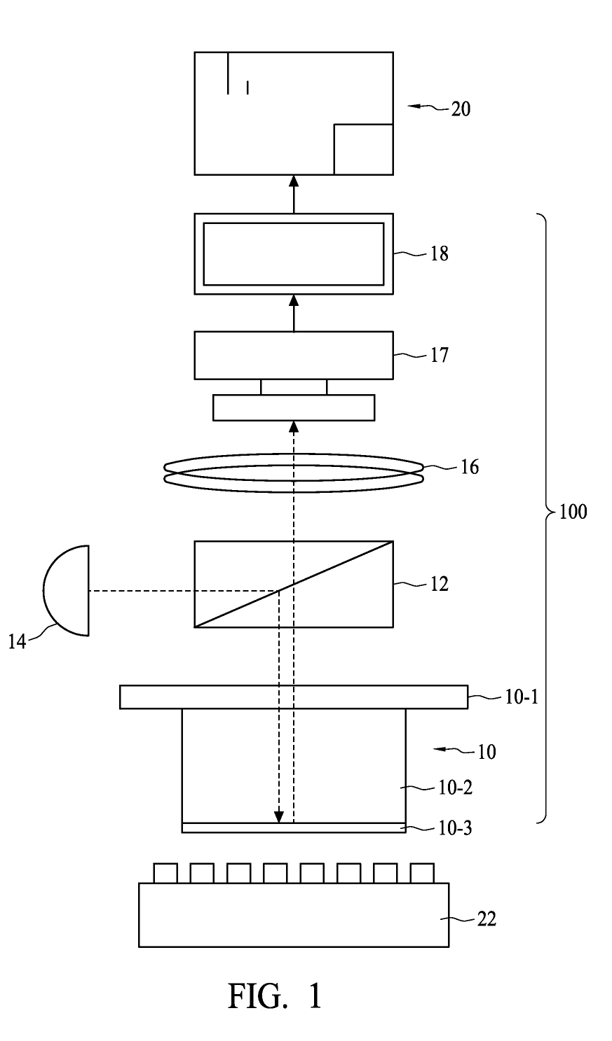

FIG. 2 illustrates a cross-sectional view of an electro optical modulator in accordance with one embodiment of the present invention;

FIG. 3 illustrates a cross-sectional view of an electro optical modulator in accordance with another embodiment of the present invention;

FIG. 4 illustrates a schematic view of an electro optical sensor in accordance with one embodiment of the present invention;

FIG. 5 illustrates a schematic view of an electro optical sensor in accordance with another embodiment of the present invention;

FIG. 6 illustrates a schematic view of an electro optical sensor in accordance with another embodiment of the present invention;

FIG. 7 illustrates a schematic view of an electro optical sensor in accordance with another embodiment of the present invention;

FIG. 8 illustrates a flow chart of a detecting method of an electro optical sensor in accordance with one embodiment of the present invention;

FIG. 9 illustrates a flow chart of a detecting method of an electro optical sensor in accordance with another embodiment of the present invention; and

FIG. 10 illustrates a flow chart of partial steps of a detecting method of an electro optical sensor in accordance with another embodiment of the present invention.

### DETAILED DESCRIPTION

The present invention is directed to an electro optical modulator, an electro optical sensor, and a detecting method thereof. In order to make the present invention easily comprehensible, detailed steps and structures are provided in the following description. Obviously, implementation of the present invention does not limit special details known by persons skilled in the art. In addition, known structures and steps are not described in detail, so as not to limit the present invention unnecessarily. Preferred embodiments of the present invention will be described below in detail. However, in addition to the detailed description, the present invention may also be widely implemented in other embodiments. The scope of the present invention is not limited to the detailed description, and is defined by the claims.

In the following description, numerous specific details are set forth. However, it should be understood that embodiments of the invention may be practiced without these specific details. In other instances, well-known methods, structures and techniques have not been shown in detail in order not to obscure an understanding of this description. References to “the present embodiment,” “an embodiment,” “another embodiment,” “other embodiments,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may. Unless specifically stated otherwise, as apparent from the following discussions, it should be appreciated that, throughout the specification, discussions utilizing terms such as “detecting,” “sensing,” “calculating,” “determining,” “judging,” “converting,” “generating,” or the like refer to the action and/or processes of a computer or computing system, or similar electronic computing device, state machine and the like that manipulate and/or transform data represented as physical, such as electronic, quantities, into other data similarly represented as physical quantities.

The present disclosure provides an electro optical modulator, an electro optical sensor, and a detecting method thereof. The present disclosure utilizes the induced electric field generated from the capacitor between a subject and the electro optical modulator to drive the electro optical modulator so as to obtain the modulated image data. In addition, since the present invention can detect the miniaturized subject in contact style or non-contact style, the present invention can be applied to flexible subjects, which cannot be detected by the conventional technique.

The electro optical modulator, the electro optical sensor, and the detecting method thereof of the present disclosure can be applied for several fields including the ITO pattern detection of the touch panel, semiconductor die detection, thin film transistor array detection, solar transparent conducting film pattern detection, and flexible display transparent conducting film pattern detection.

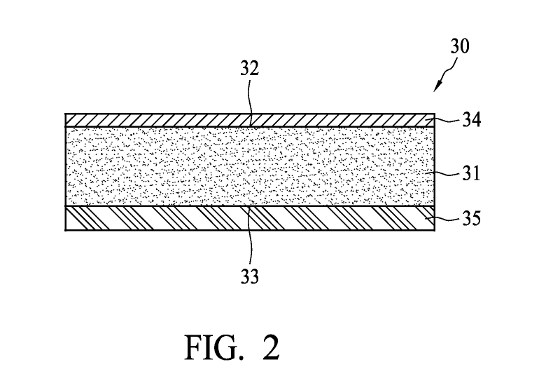

In an embodiment of the present disclosure, shown in FIG. 2, an electro optical modulator 30 includes a body 31, a conducting film 34, and a transparent film 35. The body 31 includes a first surface 32 and a second surface 33. The conducting film 34 is disposed on the first surface 32, while the transparent film 35 is disposed on the second surface 33 and is directly attached to the subject (not shown). In the embodiment, the conducting film 35 is a transparent conducting film (ITO film) and allows the light beam to penetrate therethrough. The body 31 of the electro optical modulator 30 can be a polymer dispersed liquid crystal display (PDLC display) or an optical crystal, whose material is selected from the group consisting of potassium dihydrogen phosphate, potassium dideuterium phosphate, ammonium dihydrogen phosphate, and mixtures thereof. When the conducting film 34 electrically couples with the power supply (not shown), the transparent film 35 can either remain separated from the subject or directly touch the subject to generate a capacitive effect so as to drive the electro optical modulator 31 to modulate the incident light beams for generating modulated images.

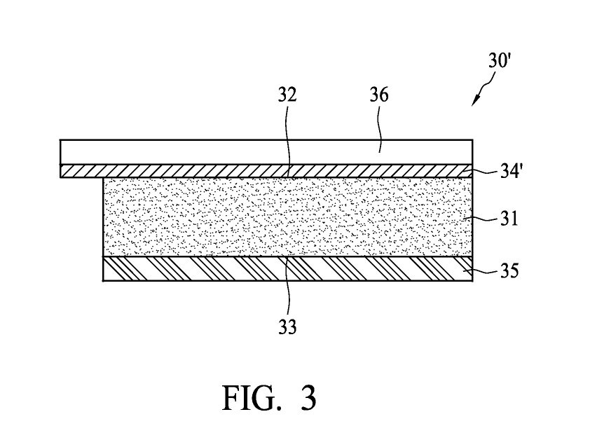

FIG. 3 illustrates another embodiment of the electro optical modulator 30′ of the present invention. The electro optical modulator 30′ includes a body 31, a conducting film 34′, a transparent film 35, and a transparent substrate 36. The structure and connecting relationship of the body 31 and the transparent film 35 are similar to those in the above-mentioned embodiment. The transparent substrate 36 is disposed on the conducting film 34′. Since the dimensions of the transparent substrate 36 are greater than those of the body 31, when the conducting film 34′ is disposed on the transparent substrate 36, the conducting film 34′ is also disposed on the transparent substrate 36 over the edge of the body 31.

In the embodiment shown in FIG. 3, since the traditional electro optical modulator is too complex, too expensive, or too vulnerable to reduce detecting cost, the present invention provides a simple electro optical modulator to achieve the same function at lower cost. The present invention utilizes transparent substrate 36 as a substrate, on which the conducting film 34′ is coated. Next, the material of the body 31 (such as PDLC or optical crystal, selected from potassium dihydrogen phosphate, potassium dideuterium phosphate, ammonium dihydrogen phosphate and mixtures thereof) is applied on the conducting film 34′. Finally, the transparent film 35 is disposed on the body 31. In the embodiment, the transparent film 35 is wear-resistant so as to protect the liquid crystal layer; meanwhile the configuration of the electro optical modulator 30′ is so simple that it can be manufactured in batch so as to reduce manufacture cost and maintenance expense.

The electro optical modulator 30 and the electro optical modulator 30′ shown in FIG. 2 and FIG. 3 do not include a mirror. In addition, the electro optical modulator 30 and the electro optical modulator 30′ of the present invention have transparent films 35 that can either directly touch the subject for detection or detect the subject in non-contact manner By such design, the electro optical modulator 30 and the electro optical modulator 30′ can detect flexible subjects or uneven subject surfaces.

The subject of the present invention is a patterned conducting film. If the conducting film is not completely etched during the pattern process, the circuit of the conducting film will different from the circuit of the original design so as to generate short circuit or open circuit. The electro optical modulator of the present invention can simultaneously detect scratches, doping, or incomplete etching.

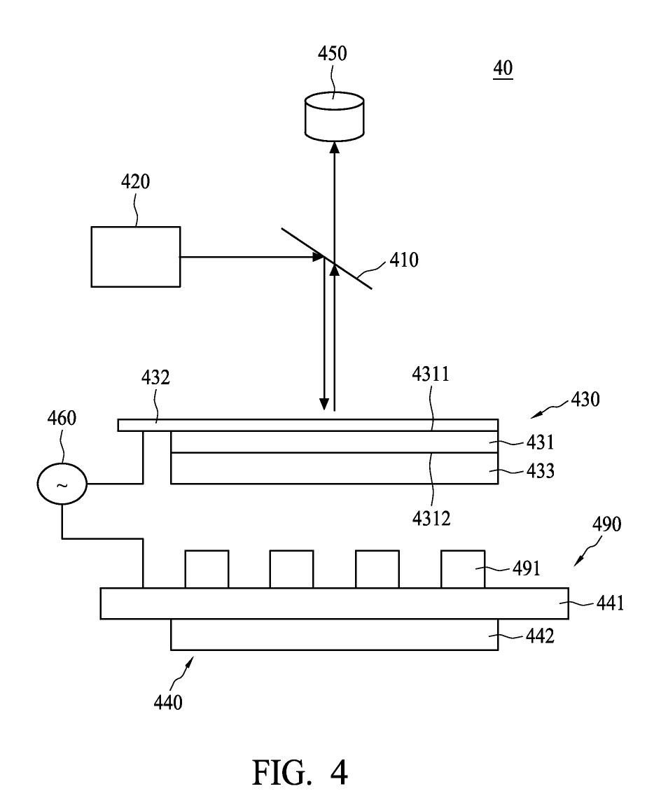

In the embodiment shown in FIG. 4, the electro optical sensor 40 includes a light source generating device 420, an electro optical modulator 430, a supporting module 440, and an image capturing module 450. The light source generating device 420 emits a light beam, which emits into the beam splitter 410 of the electro optical sensor 40. The beam splitter 410 reflects partial light beams toward the electro optical modulator 430. The electro optical modulator 430 includes a body 431, a conducting film 432, and a transparent film 433. The body 431 includes a first surface 4311 and a second surface 4312. The conducting film 432 is disposed on the first surface 4311, while the transparent film 433 is disposed on the second surface 4312 for detecting the subject 490 in direct contact style or non-contact style. Since the direct contact detection allows the electro optical modulator 430 to press the flexible subject 490, the pressed flexible subject 490 can be detected by the present disclosure for quick sensing of micro structure in the subject 490 so as to reduce the risk of inaccurate measurement of the electro optical sensor 40. The subject 490 further includes a transparent substrate 441, which includes a transparent film (such as ITO film or AZO film) In another embodiment, the transparent substrate 441 can be a flexible transparent substrate 441. The body 431 can be a polymer dispersed liquid crystal display (PDLC display) or an optical crystal, which is selected from the group consisting of potassium dihydrogen phosphate, potassium dideuterium phosphate, ammonium dihydrogen phosphate and mixtures thereof.

As shown in FIG. 4, the supporting module 440 includes a reflection mirror 442. The supporting module 440 can support the subject 490 and allows the light beams modulated by the electro optical modulator 430 to emit toward the reflection mirror 442 of the supporting module 440. The present disclosure further includes a power module 460, which electrically couples with the conducting film 432 and the transparent substrate 441 of the subject 490. When the power module 460 electrically couples with the conducting film 432 and the transparent substrate 441 and the electro optical modulator 430 approaches (e.g. touches or is disposed above) the subject 490, the transparent conducting film pattern 491 of the subject 490 generates a capacitive effect with the electro optical modulator 430 so as to generate an induced electrical field for driving the electro optical modulator 430. Since the induced electrical field will drive the electro optical modulator 430, the modulated light beam reflected from the pattern 491 of the subject 490 will form images in the electro optical modulator 430. After the light beams of the light source generating device 420 are emitted into the electro optical modulator 430, the image capturing module 450 will capture the images generated from the reflected light beams modulated by the electro optical modulator 430 and convert the images (or the light beams reflected from the electro optical modulator 430 or the reflection mirror 442) into a video signal. In accordance with the gray scale degree of the video signal, the incomplete etching of the transparent conducting film can be detected. In other words, process defects can be detected by the detecting method of the present invention so as to judge whether the circuits of the transparent conducting film are defective in accordance with the video signal.

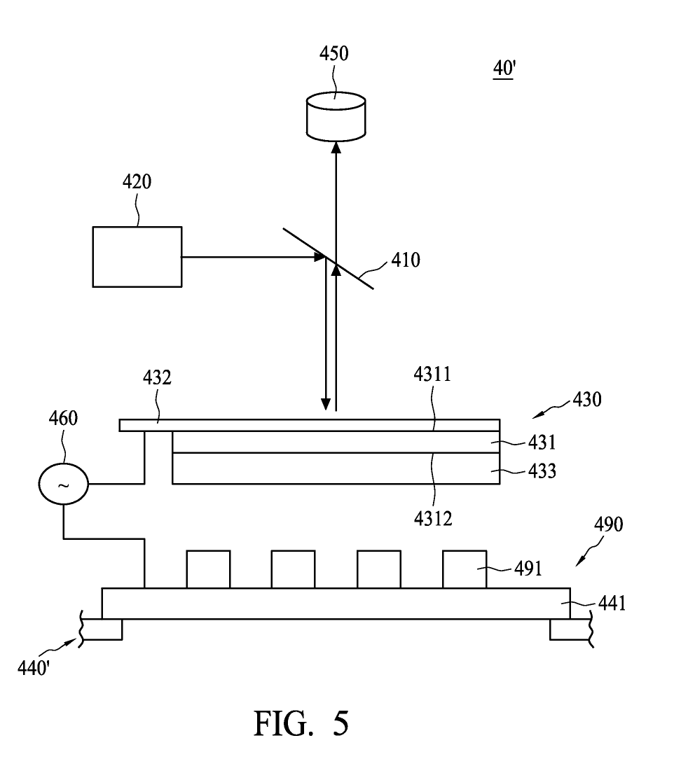

As shown in FIG. 4, after the electro optical modulator 430 modulates the light beams, partial light beams are emitted onto the subject 490. The reflection mirror 442 of the supporting module 440 is disposed under the transparent substrate 441. In the embodiment, the reflection mirror 442 directly touches the transparent substrate 441. However, in another embodiment (not shown), there is a gap between the reflection mirror 442 and the transparent 441 of the subject 490. Since the reflection mirror 442 reflects the incident light beam from the subject 490, the reflection mirror 442 can enhance the contrast value of the video images from the image capturing module 450 (such as charge-coupled device (CCD) camera or complementary metal oxide semiconductor camera) so as to reduce the risk of inaccurate measurement. However, in the embodiment shown in FIG. 5, the electro optical sensor 40′ can generate video images, wherein the supporting module 440′ of the electro optical sensor 40′ does not have any reflection mirror 442 (shown in FIG. 4).

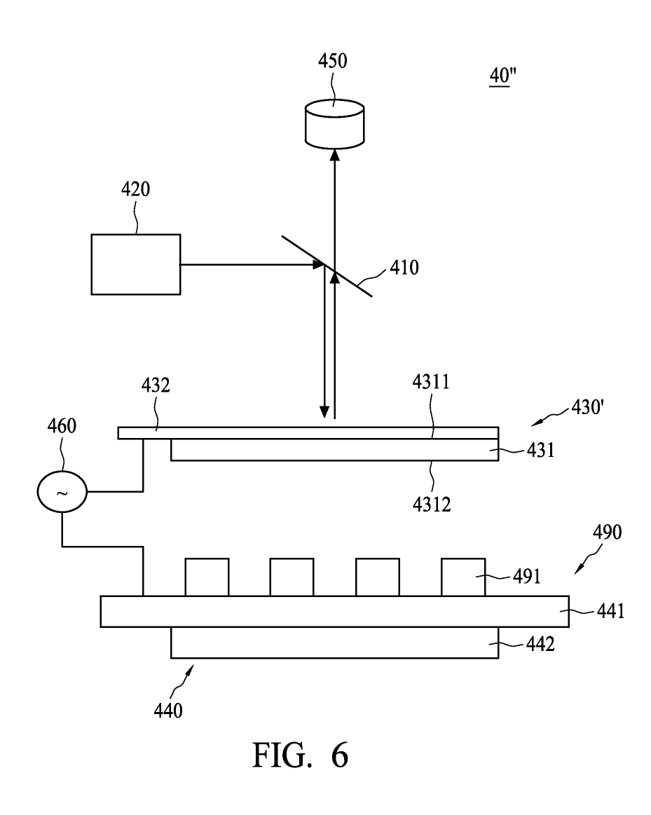

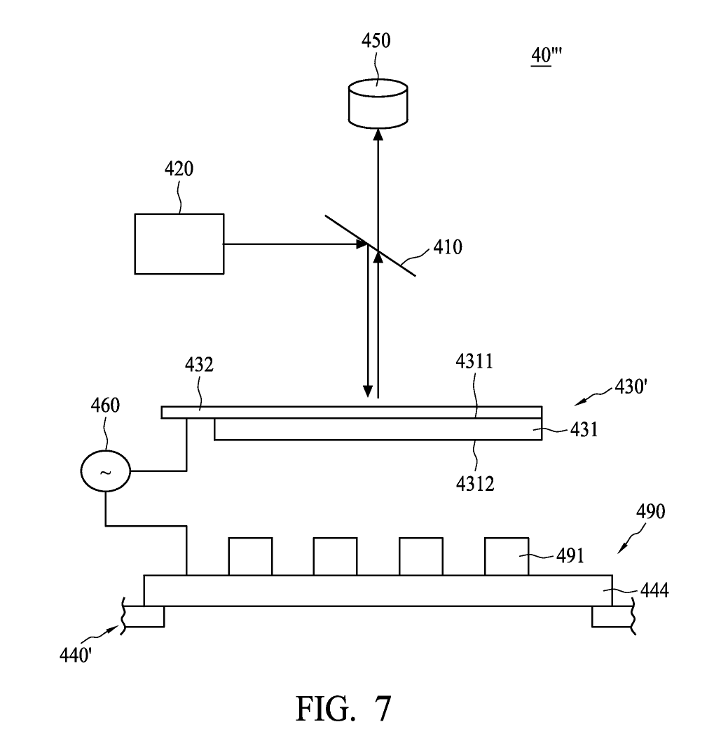

Referring to FIG. 3, the transparent substrate 36 of the electro optical modulator 30′ can be BK7 glass or polyethylene terephthalate (PET) template. In the embodiment, the thickness of the transparent film 35 preferably ranges from approximately 5 μm to 15 μm. The function of the transparent film 35 is to protect the body 31 and allows the capacitive effect between the body 31 and the subject. The material of the transparent film 35 can be metal, organic compound, inorganic compound, ceramics and so on. However, the electro optical sensors 40″, 40′″ shown in FIG. 6 and FIG. 7 and the transparent film 433 of the electro optical modulator 430′ can also be incorporated into the body 431 to enable the body 431 to be wear-resistant. The light beams of the above-mentioned embodiments of these electro optical sensors will pass through the electro optical modulator and subject. In contrast, the light beam of the conventional electro optical sensor will be reflected by the reflection mirror of the electro optical modulator, such that the light beam from the conventional electro optical sensor won't emit onto the subject. The reflection mirror 422 of the present disclosure can reflect the light beams passing through the subject to enhance the contrast value of the video signal.

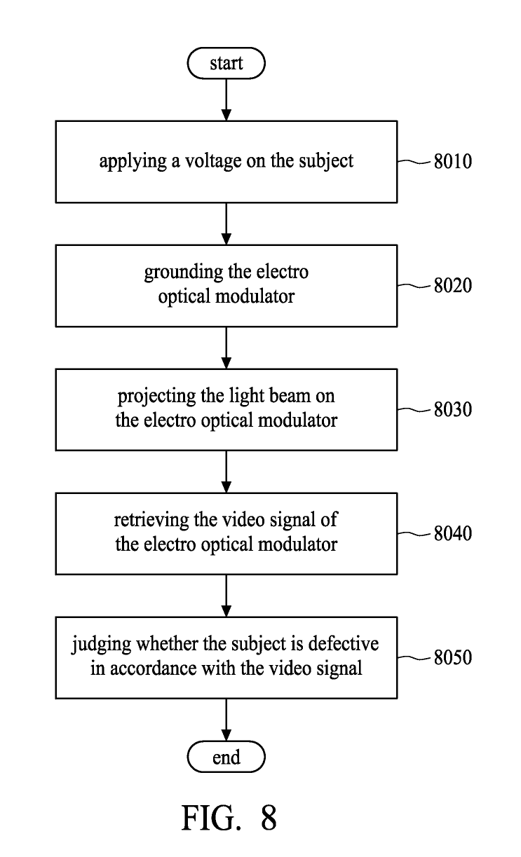

FIG. 8 illustrates a detecting method utilizing the electro optical sensor and comprising following steps: in Step 8010, a voltage is applied to the subject and Step 8020 is executed; in Step 8020, the electro optical modulator is grounded and Step 8030 is executed; in Step 8030, the light beam is projected on the electro optical modulator and Step 8040 is executed; in Step 8040, the video signal of the electro optical modulator is retrieved and Step 8050 is executed; in Step 8050, it is determined whether the subject is defective in accordance with the video signal. However, the above-mentioned steps are not limited to the number order.

The experimental results from CCD camera includes (A) if the voltage is not applied to the electro optical modulator, the gray scale value is 25; (B) if the voltage is applied to the electro optical modulator and no reflection mirror is disposed in the electro optical sensor, the gray scale value of the ITO film area is 50 and the gray scale value of the etching area is 35 such that the contrast value is 15; (c) if the voltage is applied and the sensor includes a reflection mirror, the gray scale value of ITO film area is 80 and the gray scale value of the etching area is 40 such that the contrast value is 40. Therefore, the contrast value of the electro optical sensor with the reflection mirror is 2.5 times larger than that of the electro optical sensor without the reflection mirror, which is an unexpected result.

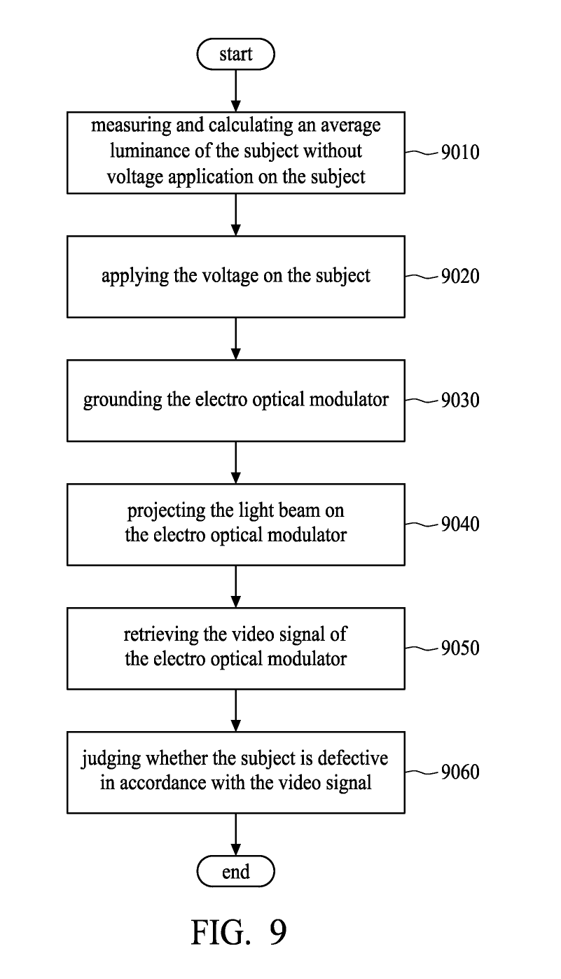

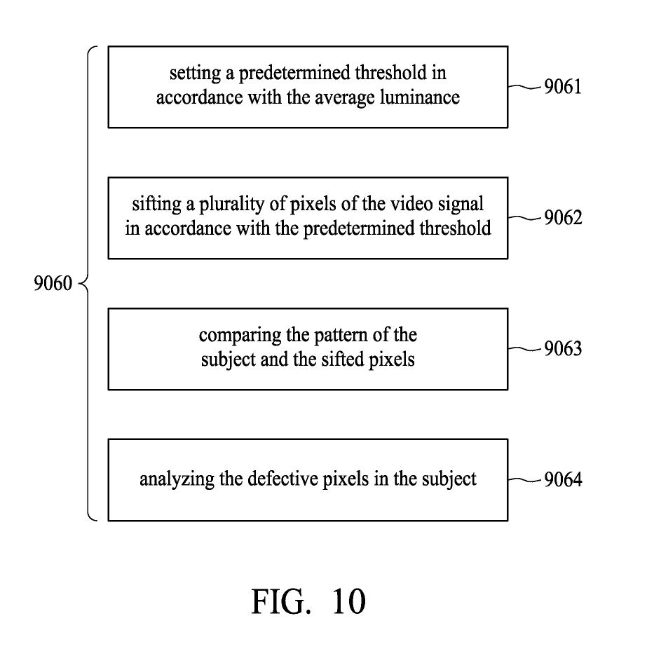

FIG. 9 illustrates another detecting method comprising the following steps: in Step 9010, an average luminance of the subject is measured and calculated without voltage application on the subject and Step 9020 is executed; in Step 9020, voltage is applied to the subject and Step 9030 is executed; in Step 9030, the electro optical modulator is grounded and Step 9040 is executed; in Step 9040, the light beam is projected onto the electro optical modulator and Step 9050 is executed; in Step 9050, the video signal of the electro optical modulator is retrieved and Step 9060 is executed; in Step 9060, it is determined whether the subject is defective in accordance with the video signal. Moreover, Step 9060 further includes Step 9061, Step 9062, Step 9063, and Step 9064 as shown in FIG. 10. Step 9061 sets a predetermined threshold in accordance with the average luminance Step 9062 sifts a plurality of pixels of the video signal in accordance with the predetermined threshold. Step 9063 compares the pattern of the subject and the sifted pixels. Step 9064 analyzes the defective pixels in the subject. However, the above-mentioned steps are not limited to the number order.

In the above-mentioned embodiments, pre-measurement and calculation of the average luminance (such as 25 units) of the subject without voltage application is performed before the video image measurement. Next, the electro optical sensor implements for detection and measurement as shown in FIG. 8. After voltage is applied, the predetermined threshold range (e.g. 40 to 45 units) is set in accordance with the types of the subjects and the average luminance Since the pattern of the subject includes many different detecting areas such as ITO film area and etch area, which have respective luminance, certain normal area (e.g. the etch area (40 unit luminance)) might be regarded as the defective area. Thus, the predetermined threshold range can sift defective pixels and normal pixels. In order to sift the defective pixels, the present disclosure can utilize a known pattern of the subject to compare with the sifted defective pixels to analyze whether defective pixels in the subject are false positive defective or substantial defective.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An electro optical modulator, comprising:
a body, including a first surface and a second surface;
a conducting film, disposed on the first surface; and
a transparent film, disposed on the second surface and located above a subject.

2. The electro optical modulator of claim 1, wherein the body is a polymer dispersed liquid crystal display (PDLC display).

3. The electro optical modulator of claim 1, wherein the body is an optical crystal, the material of the optical crystal is selected from the group consisting of potassium dihydrogen phosphate, potassium dideuterium phosphate, ammonium dihydrogen phosphate and mixtures thereof.

4. The electro optical modulator of claim 1, wherein the material of the transparent film is selected from the group consisting of metal, organic compound, inorganic compound, and ceramics.

5. An electro optical sensor, comprising:
a light source generating device, emitting a light beam;
an electro optical modulator, modulating the light beam, wherein the modulated light beam emits onto a subject;
a supporting module, supporting the subject and allowing the modulated light beam to emit onto the subject; and
an image capturing module, converting the light beam reflected from the electro optical modulator to a video signal.

6. The electro optical sensor of claim 5, wherein the electro optical modulator includes a body, a conducting film, and a transparent film, the body includes a first surface and a second surface, the conducting film is disposed on the first surface, and the transparent film is disposed on the second surface and is located above the subject.

7. The electro optical sensor of claim 6, wherein the body is a polymer dispersed liquid crystal display (PDLC display).

8. The electro optical sensor of claim 6, wherein the body is an optical crystal, and the material of the optical crystal is selected from the group consisting of potassium dihydrogen phosphate, potassium dideuterium phosphate, ammonium dihydrogen phosphate and mixtures thereof.

9. The electro optical sensor of claim 6, further comprising a power module, wherein the power module electrically couples with the conducting film and the subject.

10. The electro optical sensor of claim 6, wherein the electro optical modulator further includes a transparent substrate, the transparent substrate is disposed on the conducting film, the dimensions of the transparent substrate are greater than the dimensions of the body, and the conducting film is disposed on the transparent substrate over the body.

11. The electro optical sensor of claim 5, wherein the image capturing module is selected from a charge-coupled device camera and a complementary metal-oxide-semiconductor camera.

12. The electro optical sensor of claim 5, wherein the supporting module further includes a reflection mirror, and the reflection mirror is disposed in the supporting module and reflects the incident light beam from the subject.

13. The electro optical sensor of claim 6, wherein the material of the transparent film is selected from the group consisting of metal, organic compound, inorganic compound, and ceramics.

14. A detecting method utilizing the electro optical sensor of claim 5, comprising following steps:
applying a voltage to the subject;
grounding the electro optical modulator;
projecting the light beam onto the electro optical modulator;
retrieving the video signal of the electro optical modulator; and
judging whether the subject is defective in accordance with the video signal.

15. The detecting method of claim 14, further comprising a step of measuring and calculating an average luminance of the subject without voltage application on the subject.

16. The detecting method of claim 15, wherein the defect judging step further includes a step of setting a predetermined threshold of the average luminance and sifting a plurality of pixels of the video signal in accordance with the predetermined threshold.

17. The detecting method of claim 16, wherein the defect judging step further includes a step of comparing the pattern of the subject and the sifted pixels and analyzing the defective pixels in the subject.
